(19) United States
(12) Patent Application Publication
(10) Pub. No.: US 2025/0289934 A1
(43) Pub. Date: Sep. 18, 2025

(54) BLOWN FILMS WITH ACTIVE AGENT AND METHODS OF MAKING THE SAME

(71) Applicant: CSP TECHNOLOGIES, INC., Auburn, AL (US)

(72) Inventors: William Frederick SPANO, Auburn, AL (US); Jason PRATT, Auburn, AL (US)

(21) Appl. No.: 18/994,866

(22) PCT Filed: Jul. 17, 2023
(86) PCT No.: PCT/US2023/070336

§ 371 Date: Jan. 15, 2025

Related U.S. Application Data
(60) Provisional application No. 63/368,498, filed on Jul. 15, 2022.
(60) Provisional application No. 63/505,717, filed on Jun. 2, 2023.

(51) Int. Cl. C08J 5/18; B29C 48/00; B29C 48/10; B29C 48/36; B29C 49/00; B29C 49/04; B29K 23/00; B29K 67/00; B29L 7/00; C08K 3/34

(52) U.S. Cl. CPC C08J 5/18; B29C 48/0017; B29C 48/022; B29C 48/10; B29C 48/36; B29C 49/0005; B29C 49/04116; C08K 3/34; B29K 2023/06; B29K 2023/083; B29K 2023/18; B29K 2067/00; B29K 2995/0037; B29L 2007/008; C08J 2323/06; C08J 2323/08; C08J 2323/20; C08J 2367/00; C08J 2423/08

(57) ABSTRACT

Provided herein is a blown film material comprising base polymer and an active agent that acts on, interacts or reacts with a selected material. The active agent may be a desiccant material capable of absorbing moisture. The resulting blown film material will have useful applications. Also provided herein are related methods of manufacture.

### CROSS-REFERENCE TO RELATED APPLICATIONS

This application claims priority under 35 U.S.C. § 119(e) from U.S. Provisional Patent Application U.S. 63/505,717, entitled “BLOWN FILMS WITH ACTIVE AGENT AND METHODS OF MAKING THE SAME”, filed 2 Jun. 2023, and U.S. Provisional Patent Application U.S. 63/368,498, entitled “BLOWN FILMS WITH ACTIVE AGENT AND METHODS OF MAKING THE SAME”, filed 15 Jul. 2022, the contents of each of which are incorporated herein by reference in their entirety.

### FIELD OF INVENTION

This invention relates to blown films containing an active agent, including but not limited to desiccants for the absorption of moisture, and methods of making the same.

### BACKGROUND

There are many items that are preferably stored, shipped and/or utilized in an environment that must be controlled and/or regulated. For example, in the moisture control field, containers and/or packages having the ability to absorb excess moisture trapped therein have been recognized as desirable. The control of moisture, oxygen, ethylene and other gaseous substances may be desirable in medical, diagnostic, industrial chemical, laboratory, electronics and food packaging applications.

Conventionally, desiccants, oxygen absorbers and other active agents have been used in raw form, e.g., as loose particulates housed in sachets or canisters within packaging, to control the internal environment of the package. For many applications, it is not desired to have such loosely stored active substances. To address this problem, the assignee of the present application had developed active entrained polymers comprising active agents, wherein such polymers can be extruded and/or molded into desired forms, e.g., container liners, plugs, film sheets, pellets and other such structures. Optionally, such active entrained polymers may include channeling agents, such as polyethylene glycol (PEG), which form channels between the surface of the entrained polymer and its interior to transmit a selected material (e.g., moisture) to the entrained active agent (e.g., desiccant to absorb the moisture).

Entrained polymers may be two phase formulations (i.e., comprising a base polymer and active agent, without a channeling agent) or three phase formulations (i.e., comprising a base polymer, active agent and channeling agent). Three phase entrained polymers and methods for making the same are described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth. These entrained polymers have been conventionally made as extruded products (e.g., pellets or films) or injection molded components (e.g., pucks, inserts or liners within containers).

Blown film technology makes possible the production of useful products, including sheets, films, cylinders, and tubes. The technology is particularly valuable for fabrication of bags and packaging for consumer products. In brief, the process includes softening and melting a polymer resin, followed by inflating the material, thereby affording a bubble enclosed by a film of the material. Importantly, the film formed in this inflation process can be quite thin, typically on the order of 10 mils or less.

Although the process is straightforward in concept, the polymeric material must meet certain requirements in order to be suitable for use. Properties such as the melting point and melt index, among others, will affect the success of the blown film process in forming material with suitable properties.

There remains a need to provide blown film material comprising base polymer and active agent, particularly a particulate or mineral-based active agent.

### BRIEF SUMMARY

Accordingly, in one aspect is provided a blown film material comprising base polymer and an active agent, preferably a particulate or mineral-based active agent.

In some embodiments, the base polymer is chosen from a polyolefin and a polyester. In some embodiments, the base polymer comprises both a polyolefin and a polyester. In some embodiments, the base polymer comprises a block copolymer

In some embodiments, the active agent is a desiccant. In some embodiments, the desiccant is chosen from silica gel and molecular sieve.

In some embodiments, the blown film material further comprises a channeling agent. In some embodiments, the channeling agent is chosen from a polyglycol, glycerin polyamine, polyurethane, and polycarboxylic acid, or any combination of the foregoing. In some embodiments, the channeling agent is a water insoluble polymer. In some embodiments, the channeling agent is chosen from propylene oxide polymerisate, propylene oxide polymerisate-monobutyl ether, ethylene vinyl acetate (EVA), nylon, or any combination of the foregoing.

Also provided herein is a method to manufacture a blown film material comprising base polymer and an active agent, the method comprising the steps of:
extruding a suitable precursor material (molten mix of a polymer and an active agent) in a screw extruder with warming;
passing the warmed material through a tubular die;
expanding and stretching the warmed material with positive pressure; and
allowing the expanded and stretched material to cool.

### BRIEF DESCRIPTION OF THE DRAWINGS

A full understanding of the invention can be gained from the following description of the preferred embodiments when read in conjunction with the accompanying drawings in which:

FIG. 1 is a perspective view of a plug formed of an entrained polymer that may be deposited onto a substrate according to methods of the disclosed concept;

FIG. 2 is a cross section taken along line 2-2 of FIG. 1;

FIG. 3 is a cross section similar to that of FIG. 2, showing a plug formed of another embodiment of an entrained polymer according to an optional embodiment of the disclosed concept;

FIG. 4 is a schematic illustration of an entrained polymer according to an optional embodiment of the disclosed concept, in which the active agent is a scavenging material;

FIG. 5 is a cross sectional view of a sheet or film formed of an entrained polymer according to an optional embodiment of the disclosed concept, adhered to a barrier sheet substrate;

FIG. 6 is a cross section of a package that may be formed using an entrained polymer according to an optional embodiment of the disclosed concept;

FIG. 7 is a schematic drawing depicting representative equipment and an associated process for forming blown film material;

FIG. 8 is a photograph showing blown film samples rated as “G” (good).

FIG. 9 is a photograph showing blown film samples rated as “F” (fair).

FIG. 10 is a photograph showing blown film samples rated as “P” (poor).

FIG. 11 depicts moisture uptake for blown films comprising SYLOSIV® K360 and EXACT™ 3040 (vertical axis=g/day); and

FIG. 12 depicts moisture uptake for blown films comprising SYLOSIV® K360 with mixtures of EXACT™ 3040 and HYTREL® 7246 (vertical axis=g/day).

### DETAILED DESCRIPTION OF PREFERRED EMBODIMENTS

In one aspect, there is provided herein a blown film material comprising a base polymer and an active agent.

In some embodiments, the base polymer is chosen from a polyolefin, a polyamide, and a polyester. In some embodiments, the base polymer is chosen from a polyolefin and a polyester. In some embodiments, the base polymer is chosen from polyethylene, polypropylene, a polyethylene/polypropylene copolymer, and poly(lactic acid).

In some embodiments, the base polymer has the formula (—CHR—X—)ₙ with —X— chosen from —CH₂—, —COO—, and —CONH—, and R chosen from H and n-C₁₋₁₀alkyl.

In some embodiments, the base polymer comprises at least one block copolymer.

In some embodiments, the base polymer comprises a block copolymer that comprises a block of ester monomers. In some further embodiments, the base polymer comprises a block copolymer that comprises a block of poly(alkylene) terephthalate monomers. In some further embodiments, the alkylene is chosen from ethylene, propylene, and butylene.

In some embodiments, the base polymer comprises a block copolymer that comprises a block of polyether glycols.

In some embodiments, the base polymer comprises a block copolymer that contains both a block of ester monomers and a block of polyether glycols. In some embodiments, the base polymer comprises a HYTREL® block copolymer. In some embodiments, the base polymer comprises HYTREL® 7246.

In some embodiments, the base polymer comprises an ethylene/alpha-olefin copolymer. In some further embodiments, the alpha-olefin is chosen from propylene, 1-butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. In some further embodiments, the alpha-olefin is chosen from propylene, 1-butene, 1-pentene, 1-hexene, 1-heptene, 1-octene, 1-nonene, 1-decene, and 1-dodecene.

In some embodiments, the base polymer comprises two block copolymers. In some further embodiments, one of the two block copolymers is an ethylene/alpha-olefin copolymer as disclosed herein. In some further embodiments, the base polymer comprises EXACT™ 3040. In some further embodiments, one of the two block copolymers is a block copolymer that contains both a block of ester monomers and a block of polyether glycols as disclosed herein. In some further embodiments, the base polymer comprises HYTREL® 7246. In some further embodiments, the base polymer comprises both EXACT™ 3040 and HYTREL® 7246. In some further embodiments, the base polymer consists of a mixture of EXACT™ 3040 and HYTREL® 7246.

In some embodiments, the base polymer comprises both a polyolefin and a polyester. In some embodiments, the polyolefin ranges from 10% and 40% by weight of the total composition, optionally between 15% and 30%. In some embodiments, the polyester ranges from 20% and 80% by weight of the total composition, optionally between 25% and 70%, optionally 30% and 60%. In some embodiments, the polyolefin has formula (—CH₂CHR—)ₙ, and R is chosen from H and n-C₁₋₁₀alkyl. In some embodiments, the polyester has formula ((—CH₂)ₘCOO—)ₙ, and m is chosen from 1, 2, 3, 4, and 5. In some embodiments, the polyester has formula (—CHRCOO—)ₙ, and R is chosen from H and n-C₁₋₁₀alkyl.

In some embodiments, the active agent is a desiccant. In some embodiments, the desiccant is chosen from silica gel and molecular sieve. In some embodiments, the desiccant does not contain a metal oxide. In some embodiments, the desiccant does not contain a metal carbonate. In some embodiments, the desiccant does not contain a metal halide.

In any embodiment, the active agent is preferably a particulate, granular and/or mineral-based material and is optionally present in at least 35% to 70%, optionally from 40% to 60%, optionally from 45% to 55% by weight with respect to the total weight of the entrained polymer.

In some embodiments, the blown film material further comprises a channeling agent. In some embodiments, the channeling agent is chosen from a polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid.

In some embodiments, the channeling agent is a water insoluble polymer, such as a propylene oxide polymerisate-monobutyl ether, such as Polyglykol B01/240, produced by CLARIANT. In other embodiments, the channeling agent could be a propylene oxide polymerisate monobutyl ether, such as Polyglykol B01/20, produced by CLARIANT, propylene oxide polymerisate, such as Polyglykol D01/240, produced by CLARIANT, ethylene vinyl acetate (EVA), nylon 6, nylon 66, or any combination of the foregoing.

In some embodiments, the base polymer has a formula chosen from (—CH₂CHR—)ₙ and (—CHRCOO—)ₙ, with R chosen from H and n-C₁₋₁₀alkyl. In some embodiments, R is chosen from H and n-C₁₋₁₀alkyl. In some embodiments, R is chosen from H, CH₃, C₂H₅, n-C₄H₉, n-C₆H₁₃, and n-C₈H₁₇. In some embodiments, R is chosen from C₂H₅, n-C₄H₉, and n-C₆H₁₃.

Also provided herein is a method of manufacture for a blown film material as disclosed herein, the method comprising the steps of:
extruding a suitable precursor material in a screw extruder with warming;
passing the warmed material through a tubular die;
expanding and stretching the warmed material with positive pressure; and
allowing the expanded and stretched material to cool.

In some embodiments, the extrusion is performed at a temperature between 140° C. and 190° C., optionally between 145° C. and 175° C., optionally between 150° C. and 170° C., optionally between 150° C. and 165° C. As used herein, the term “between” includes the endpoints of a stated numerical range.

In some embodiments, the extrusion is performed with a rotation speed of 5 rpm or greater, optionally 10 rpm or greater, optionally 15 rpm or greater, optionally 25 rpm or greater, optionally 35 rpm or greater, optionally 45 rpm or greater, optionally 55 rpm or greater.

In some embodiments, the extrusion is performed with a rotation speed of 65 rpm or less, optionally 55 rpm or less, optionally 45 rpm or less, optionally 35 rpm or less, optionally 30 rpm or less, optionally 25 rpm or less, optionally 20 rpm or less.

In some embodiments, the extrusion is performed with a rotation speed of between 10 rpm and 75 rpm, optionally between 15 rpm and 65 rpm, optionally between 15 rpm and 60 rpm, optionally between 20 rpm and 50 rpm.

In some embodiments, the extrusion is performed with a rotation speed of between 5 rpm and 35 rpm, optionally between 10 rpm and 30 rpm, optionally between 10 rpm and 25 rpm, optionally between 10 rpm and 20 rpm.

In some embodiments, the tensile strength of the blown film material is significantly different from that of a comparable cast extruded film material. In some embodiments, the tensile strength of the blown film material is significantly greater than that of a comparable cast extruded film material.

In some embodiments, the dart impact resistance of the blown film material is significantly different from that of a comparable cast extruded film material. In some embodiments, the dart impact resistance of the blown film material is significantly greater than that of a comparable cast extruded film material.

In some embodiments, the transparency of the blown film material is significantly different from that of a comparable cast extruded film material. In some embodiments, the transparency of the blown film material is significantly greater than that of a comparable cast extruded film material.

In some embodiments, the haze of the blown film material is significantly different from that of a comparable cast extruded film material. In some embodiments, the haze of the blown film material is significantly greater than that of a comparable cast extruded film material.

In some embodiments, the brittleness of the blown film material is significantly different from that of a comparable cast extruded film material. In some embodiments, the brittleness of the blown film material is significantly less than that of a comparable cast extruded film material.

In some embodiments, the density of the blown film material is significantly different from that of a comparable cast extruded film material. In some embodiments, the density of the blown film material is significantly greater than that of a comparable cast extruded film material. In some embodiments, the density of the blown film material is significantly less than that of a comparable cast extruded film material.

In some embodiments, the tensile strength of the blown film material in the machine and/or direction is significantly different from that of a comparable cast extruded film material. In some embodiments, the tensile strength of the blown film material in the machine and/or direction is significantly greater than that of a comparable cast extruded film material.

In some embodiments, the elongation of the blown film material in the machine and/or direction is significantly different from that of a comparable cast extruded film material. In some embodiments, the elongation of the blown film material in the machine and/or direction is significantly greater than that of a comparable cast extruded film material.

In some embodiments, the Young's modulus of the blown film material in the machine and/or direction is significantly different from that of a comparable cast extruded film material. In some embodiments, the Young's modulus of the blown film material in the machine and/or direction is significantly greater than that of a comparable cast extruded film material.

Also provided herein is a container which comprises a blown film entrained polymer as disclosed herein and an interior space suitable for storage of a product. Such product may include, e.g., food, a medicament, a medical device or a drug delivery device, for example. In some embodiments, the container comprises at least one article, comprising a blown film entrained polymer as disclosed herein, located within the interior space. In some embodiments, inclusion of the product within the container creates a headspace formed by the interior space that is not occupied by the product. In some embodiments, the container comprises a bottom surface, a top opening, and one or more sidewalls extending in a vertical direction from the bottom surface to the top opening. In some embodiments, the container further comprises a cover to close and/or seal the container.

### Definitions

As used herein, the term “active” is defined as capable of acting on, interacting with or reacting with a selected material (e.g., moisture or oxygen) according to the invention. Examples of such actions or interactions may include absorption, adsorption or release of the selected material.

As used herein, the term “active agent” is defined as a material that (1) is immiscible with the base polymer and when mixed and heated with the base polymer and the channeling agent, will not melt, i.e., has a melting point that is higher than the melting point for either the base polymer or the channeling agent, and (2) acts on, interacts or reacts with a selected material. The term “active agent” may include but is not limited to materials that absorb, adsorb or release the selected material(s). Active agents according to the invention may be in the form of particles, preferably minerals, but the invention should generally not be viewed as limited only to particulate active agents (unless a respective claim recites otherwise).

As used herein, the term “polyolefin” refers to a polymer with formula (—CH₂CHR—)ₙ, with R chosen from H, alkyl, chloro, aryl, hydroxy, acyloxy, acetoxy, carboxy, and alkoxycarbonyl. In some embodiments, R is chosen from H, alkyl, and phenyl. In some embodiments, R is chosen from H and C₁₋₁₀alkyl. In some embodiments, R is chosen from H and n-C₁₋₁₀alkyl. In some embodiments, R is chosen from H and CH₃. In some embodiments, the polyolefin is chosen from polyethylene, low-density polyethylene (“LDPE”), linear low-density polyethylene (LLDPE), very-low-density polyethylene (VLDPE), ultra-low-density polyethylene (ULDPE), and medium-density polyethylene (MDPE).

As used herein, the term “polyester” refers to a polymer with formula (—X—COO—)ₙ, with X being a bivalent organic moiety. In some embodiments, the polyester has the formula (—CHRCOO—)ₙ, with R chosen from H and n-C₁₋₁₀alkyl. In some embodiments, the polyester has the formula ((—CH₂)ₘCOO—)ₙ, wherein m is chosen from 1, 2, 3, 4, and 5. In some embodiments, the polyester has the formula (—OOC—Y—COO—Z)ₙ, with Y and Z both being bivalent organic moieties. In some embodiments, Y=1,4-phenylene. In some embodiments, Z is chosen from ethylene, butylene (tetramethylene), hexylene (hexamethylene), and 1,4-cyclohexenedimethylene. In some embodiments, the polyester is polyethylene terephthalate (“PET”). In some embodiments, the polyester is poly-1,4-cyclohexylene-dimethylene terephthalate (“PCDT”).

As used herein, the term “base polymer” is a polymer optionally having a gas transmission rate of a selected material that is substantially lower than, lower than or substantially equivalent to, that of the channeling agent. By way of example, such a transmission rate would be a water vapor transmission rate in embodiments where the selected material is moisture and the active agent is a water absorbing desiccant. The primary function of the base polymer is to provide structure for the entrained polymer. Suitable base polymers may include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylonitrile, polysulfones, polyacrylic ester, acrylic, polyurethane and polyacetal, or copolymers or mixtures thereof.

Referring to such a comparison of the base polymer and channeling agent water vapor transmission rate, in one embodiment, the channeling agent has a water vapor transmission rate of at least two times that of the base polymer. In another embodiment, the channeling agent has a water vapor transmission rate of at least five times that of the base polymer. In another embodiment, the channeling agent has a water vapor transmission rate of at least ten times that of the base polymer. In still another embodiment, the channeling agent has a water vapor transmission rate of at least twenty times that of the base polymer. In still another embodiment, the channeling agent has a water vapor transmission rate of at least fifty times that of the base polymer. In still another embodiment, the channeling agent has a water vapor transmission rate of at least one hundred times that of the base polymer.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

As used herein, the term “channels” or “interconnecting channels” is defined as passages formed of the channeling agent that penetrate through the base polymer and may be interconnected with each other.

As used herein, the term “entrained polymer” is defined as a monolithic material formed of at least a base polymer with an active agent and optionally also a channeling agent entrained or distributed throughout. An entrained polymer thus includes two-phase polymers and three phase polymers. A “mineral loaded polymer” is a type of entrained polymer, wherein the active agent is in the form of minerals, e.g., mineral particles such as molecular sieve or silica gel.

As used herein, the term “monolithic,” “monolithic structure” or “monolithic composition” is defined as a composition or material that does not consist of two or more discrete macroscopic layers or portions. Accordingly, a “monolithic composition” does not include a multi-layer composite (although it may be part of a multi-layer composite).

As used herein, the term “phase” is defined as a portion or component of a monolithic structure or composition that is uniformly distributed throughout, to give the structure or composition it's monolithic characteristics.

As used herein, the term “selected material” is defined as a material that is acted upon by, or interacts or reacts with an active agent and is capable of being transmitted through the channels of an entrained polymer. For example, in embodiments in which a desiccant is used as an active agent, the selected material may be moisture or a gas that can be absorbed by the desiccant.

As used herein, the term “three phase” is defined as a monolithic composition or structure comprising three or more phases. An example of a three phase composition according to the invention would be an entrained polymer formed of a base polymer, active agent, and channeling agent. Optionally, a three phase composition or structure may include an additional phase, e.g., a colorant (thus “three phase” indicates at least three phases, including a base polymer, active agent and channeling agent).

Suitable channeling agents may include a polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent 35 can be, for example, a water insoluble polymer, such as a propylene oxide polymerisate-monobutyl ether, such as Polyglykol B01/240, produced by CLARIANT. In other embodiments, the channeling agent could be a propylene oxide polymerisate monobutyl ether, such as Polyglykol B01/20, produced by CLARIANT, propylene oxide polymerisate, such as Polyglykol D01/240, produced by CLARIANT, ethylene vinyl acetate (EVA), nylon 6, nylon 66, or any combination of the foregoing.

If the active agent is a desiccant, any suitable desiccant for a given application may be used. Typically, physical absorption desiccants are preferred for many applications. These may include molecular sieves, silica gels, clays and starches. Alternatively, the desiccant may be a chemical compound that forms crystals containing water or compounds which react with water to form new compounds.

Suitable absorbing materials may, in optional embodiments, also include: (1) metals and alloys such as, but not limited to, nickel, copper, aluminum, silicon, solder, silver, gold; (2) metal-plated particulates such as silver-plated copper, silver-placed nickel, silver-plated glass microspheres; (3) inorganics such as BaTiO₃, SrTiO₃, SiO₂, Al₂O₃, ZnO, TiO2, MnO, CuO, Sb₂O₃, WC, fused silica, fumed silica, amorphous fused silica, sol-gel silica, sol-gel titanates, mixed titanates, ion exchange resins, lithium-containing ceramics, hollow glass microspheres; (4) carbon-based materials such as carbon, activated charcoal, carbon black, ketchem black, diamond powder; (5) elastomers, such as polybutadiene, polysiloxane, and semi-metals, ceramic and; (6) other fillers and pigments.

In another example, the absorbing material may be a carbon dioxide scavenger, such as calcium oxide. In the presence of moisture and carbon dioxide, the calcium oxide is converted to calcium carbonate. Accordingly, calcium oxide may be used as the absorbing material in applications where absorption of carbon dioxide is needed. Such applications include preserving fresh foods (e.g., fruits and vegetables) that give off carbon dioxide.

Other suitable active agents according to the invention include releasing materials. Such materials may comprise any suitable material that will release the selected material from the releasing material. The selected material released from the releasing material could be in the form of a solid, gel, liquid or gas. These substances can perform a variety of functions including: serving as a fragrance, flavor, or perfume source; supplying a biologically active ingredient such as pesticide, pest repellent, antimicrobials, bait, aromatic medicines, etc.; providing humidifying or desiccating substances; delivering air-borne active chemicals, such as corrosion inhibitors; ripening agents and odor-making agents.

Suitable biocides for use as releasing materials in the entrained polymers of the present invention may include, but are not limited to, pesticides, herbicides, nematacides, fungicides, rodenticides and/or mixtures thereof. In addition to the biocides, the covering of the present invention can also release nutrients, plant growth regulators, pheromones, defoliants and/or mixture thereof.

Quaternary ammonium compounds can also be used as releasing materials according to the invention. Such compounds not only function as surfactants, but also impart to the surface of the entrained polymer aseptic properties or establish conditions for reducing the number of microbial organisms, some of which can be pathogenic. Numerous other antimicrobial agents, such as benzalkonium chloride and related types of compounds as hexachlorophene, may also be used as releasing agents according to the invention.

Other potential releasing materials include fragrances, including natural, essential oils and synthetic perfumes, and blends thereof. Typical perfumery materials which may form part of, or possibly the whole of, the active ingredient include: natural essential oils such as lemon oil, mandarin oil, clove leaf oil, petitgrain oil, cedar wood oil, patchouli oil, lavandin oil, neroli oil, ylang oil, rose absolute or jasmin absolute; natural resins such as labdanum resin or olibanum resin; single perfumery chemicals which may be isolated from natural sources or manufactured synthetically, as for example alcohols such as geraniol, nerol, citronellol, linalool, tetrahydrogeraniol, betaphenylethyl alcohol, methyl phenyl carbinol, dimethyl benzyl carbinol, menthol or cedrol; acetates and other esters derived from such alcohols-aldehydes such as citral, citronellal, hydroxycitronellal, lauric aldehyde, undecylenic aldehyde, cinnamaldehyde, amyl cinnamic aldehyde, vanillin or heliotropin; acetals derived from such aldehydes; ketones such as methyl hexyl ketone, the ionones and methylionones; phenolic compounds such as eugenol and isoeugenol; synthetic musks such as musk xylene, musk ketone and ethylene brassylate.

In some embodiments, the base polymer ranges from 10% to 90% by weight of the total composition, optionally from 20% to 80% by weight, optionally from 30% to 70% by weight, optionally from 40% to 60% by weight.

In some embodiments, the base polymer ranges from 20% to 90% by weight of the total composition, optionally from 30% to 80% by weight, optionally from 40% to 70% by weight, optionally from 50% to 60% by weight.

In some embodiments, the base polymer ranges from 30% to 90% by weight of the total composition, optionally from 40% to 80% by weight, optionally from 50% to 70% by weight.

When an optional channeling agent is employed, the channeling agent may be provided in a range of 1% to 15% by weight, optionally 2% to 12%, optionally about 5%.

It is believed that the higher the active agent concentration in the mixture, the greater the absorption, adsorption or releasing capacity (as the case may be) will be of the final composition. However, too high an active agent concentration could cause the entrained polymer to be more brittle and the molten mixture of active agent, base polymer and channeling agent to be more difficult to either thermally form, extrude or successfully form a bubble in a blown film production process.

In some embodiments, the active agent loading level can range from 10% to 80%, optionally 35% to 70%, optionally from 40% to 60%, optionally from 45% to 55% by weight with respect to the total weight of the entrained polymer.

In some embodiments, the active agent loading level can range from 10% to 70%, optionally 30% to 60%, optionally from 35% to 50% by weight with respect to the total weight of the entrained polymer.

In some embodiments, the active agent loading level can range from 10% to 60%, optionally 20% to 50%, optionally from 25% to 45% by weight with respect to the total weight of the entrained polymer.

In some embodiments, the active agent loading level can range from 10% to 50%, optionally 15% to 45%, optionally from 20% to 40%, optionally from 25% to 35%, by weight with respect to the total weight of the entrained polymer.

Optionally, channeling agent may be provided in a range of 1% to 15% by weight, optionally 2-12%, optionally 5-12%, optionally about 10%, optionally about 9%, optionally about 8%, optionally about 7%, optionally about 6%, optionally about 5%, optionally about 4%, optionally about 3%, optionally about 2%. Optionally, the base polymer may range from 10% to 65% by weight of the total composition, optionally from 20% to 45% by weight, optionally from 25% to 35% by weight. Optionally, a colorant is added, e.g., at about 0.5-2% or at about 1% by weight of the total composition. Combination of any of the above ranges with respect to the base polymer, active agent, channeling agent, and colorant is contemplated.

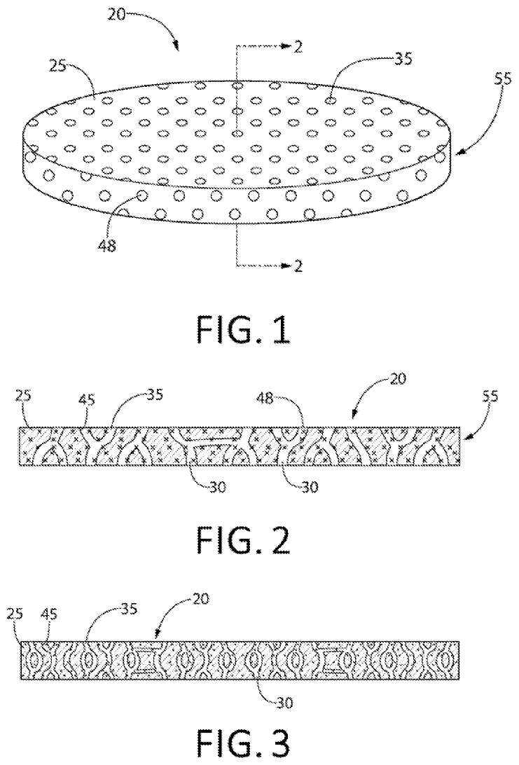

FIGS. 1-6 illustrate entrained polymers 20 and various packaging assemblies formed of entrained polymers according to certain embodiments of the disclosure. The entrained polymers 20 each include a base polymer 25, optionally a channeling agent 35 and an active agent 30. As shown, the channeling agent 35 forms interconnecting channels 45 through the entrained polymer 20. At least some of the active agent 30 is contained within these channels 45, such that the channels 45 communicate between the active agent 30 and the exterior of the entrained polymer 20 via channel openings 48 formed at outer surfaces of the entrained polymer 25. The active agent 30 can be, for example, any one of a variety of releasing materials, as described in further detail below. While a channeling agent, e.g., 35, is preferred, the disclosure broadly includes entrained polymers that optionally do not include a channeling agent.

FIG. 1 shows a plug 55 constructed of an entrained polymer 20, in accordance with certain embodiments of the invention. The plug 55 may be placed inside of a container. As aforementioned, the entrained polymer 20 includes a base polymer 25, a channeling agent 35 and an active agent 30.

FIG. 2 shows a cross-sectional view of the plug 55 shown in FIG. 1. In addition, FIG. 2 shows that the entrained polymer 20 has been solidified such that the channeling agent 35 forms interconnecting channels 45 to establish passages throughout the solidified plug 55. At least some of the active agent 30 is contained within the channels 45, such that the channels 45 communicate between the active agent 30 and the exterior of the entrained polymer 20 via channel openings 48 formed at outer surfaces of the entrained polymer 25.

FIG. 3 illustrates an embodiment of a plug 55 having similar construction and makeup to the plug 55 of FIG. 2, where interconnecting channels 45 are finer as compared to those shown in FIG. 2. This can result from the use of a dimer agent (i.e., a plasticizer) together with a channeling agent 35. The dimer agent may enhance the compatibility between the base polymer 25 and the channeling agent 35. This enhanced compatibility is facilitated by a lower viscosity of the blend, which may promote a more thorough blending of the base polymer 25 and channeling agent 35, which under normal conditions can resist combination into a uniform solution. Upon solidification of the entrained polymer 20 having a dimer agent added thereto, the interconnecting channels 45 which are formed there-through have a greater dispersion and a smaller porosity, thereby establishing a greater density of interconnecting channels throughout the plug 55.

Interconnecting channels 45, such as those disclosed herein, facilitate transmission of a desired material, such as moisture, gas or odor, through the base polymer 25, which generally acts as a barrier to resist permeation of these materials. For this reason, the base polymer 25 itself acts as a barrier substance within which an active agent 30 may be entrained. The interconnecting channels 45 formed of the channeling agent 35 provide pathways for the desired material to move through the entrained polymer 10. Without these interconnecting channels 45, it is believed that relatively small quantities of the desired material would be transmitted through the base polymer 25 to or from the active agent 30. Additionally, wherein the desired material is transmitted from the active agent 30, it may be released from the active agent 30, for example in embodiments in which the active agent 30 is a releasing material, such as an antimicrobial gas releasing material.

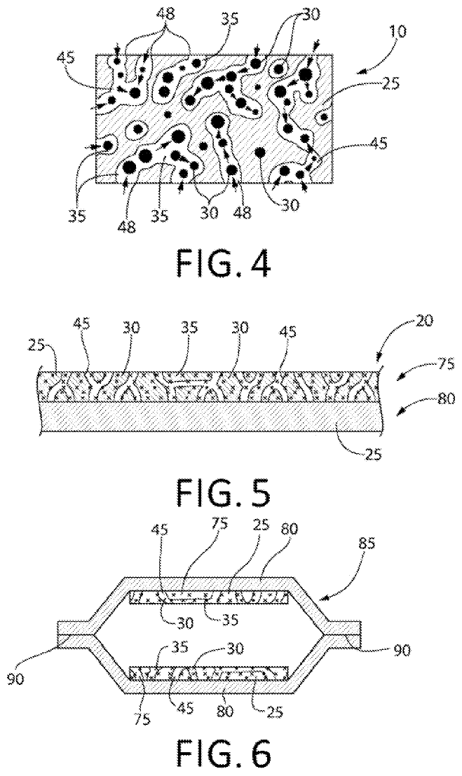

FIG. 4 illustrates an embodiment of an entrained polymer 10 according to the disclosure. The arrows indicate the path of a selected material, for example moisture, from an exterior of the entrained polymer 10, through the channels 45, to the particles of active agent 30.

FIG. 5 illustrates an active sheet or film 75 formed of the entrained polymer 20 used in combination with a barrier sheet 80 to form a composite, according to an aspect of the invention. The characteristics of the active sheet or film 75 are similar to those described with respect to the plug 55. The barrier sheet 80 may be a substrate such as foil and/or a polymer with low moisture or oxygen permeability. The barrier sheet 80 is compatible with the entrained polymer structure 75 and is thus configured to thermally bond to the active sheet or film 75, when the active sheet or film 75 solidifies after dispensing.

FIG. 6 illustrates an embodiment in which the active sheet or film 75 and the barrier sheet 80 are combined to form a packaging wrap having active characteristics at an interior surface formed by the entrained polymer 20 in the active sheet or film 75, and vapor resistant characteristics at an exterior surface formed by the barrier sheet 80. In this embodiment, the active sheet or film 75 occupies a portion of the barrier sheet 80. The methods according to the invention for making the active sheet or film 75 and adhering it to the barrier sheet 80 are particularly limited.

In one embodiment, the sheets of FIG. 5 are joined together to form an active package 85, as shown in FIG. 6. As shown, two laminates or composites are provided, each formed of an active sheet or film 75 joined with a barrier sheet 80. The sheet laminates are stacked, with the active sheet or film 75 facing one another, so as to be disposed on an interior of the package, and are joined at a sealing region 90, formed about a perimeter of the sealed region of the package interior.

In some embodiments, the entrained polymer is positioned in a container and substantially all of the interior-facing part of the container is composed of the entrained polymer. In some embodiments, the container is fabricated so that the entrained polymer is located below the level of a liquid medium contained in the package, thereby providing direct contact between the active agent and the liquid medium.

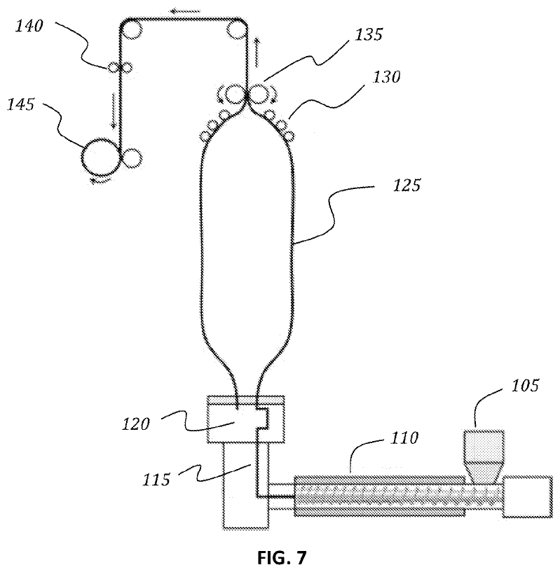

A representative process for forming blow film material is depicted in FIG. 7. A precursor resin, in the form of pellets, is fed into hopper 105 where screw 110 rotates and forces the material forward while heat is applied, gradually forming a melt. The molten material 115 then flows through die 120, resulting in a hollow tube of material. Bubble 125 is formed in the material by introduction of air via a hole in the center of the die. The material progresses upward around the bubble, is cooled, and eventually is allowed to collapse through the action of collapsing frame 130. Throughout this step, nip rolls 135 pull the material upward and maintain proper tension. The collapsed material passes through a series of rollers, including edge trim 140, and is eventually taken up on winder 145.

Due to the nature of the blown film process, certain physical characteristics of the resulting film material may be significantly different than for films manufactured using other techniques, for example cast film extrusion. For example, a cast film process can produce a film with low and/or nonuniform orientation of the polymer strands within the material. In contrast, a blown film material may be highly oriented, with orientation uniform across the cylindrical bubble.

In turn, orientation of the polymer strands within the material can influence the degree of crystallinity, which can affect properties such as clarity/haze, tear strength and elongation, puncture resistance, and toughness.

Mechanical properties in a blown film can be significantly different than those for a cast film. In the blown film process, the material is drawn in both the transverse and machine directions. In contrast, tentered films can have nonuniform strengths in these two directions.

Other mechanical parameters which can be different in blown films and comparable cast films, in either or both of machine and transverse directions, when applicable, are Young's modulus, dart impact resistance, transparency, brittleness, and density.

The strength of a blown film can be different from that of a comparable cast film. Generally, the tensile strength of a blown film is comparable in the machine and transverse film directions. Elongation of a blown film is similar in the machine and transverse film directions.

Another important feature of the blown film process is that the rate of cooling of the film can be adjusted. In this way, the transparency of the film can be modulated.

Optionally, in any embodiment, the aforementioned extrusion process includes coextrusion of two or more layers wherein at least one such layer is the active layer (mixture of polymer and active agent) and at least another such layer is a polymer material without an active agent incorporated therein. In such embodiments, what may be formed is a multilayer composite in which at least one layer is an active entrained polymer layer.

Various aspects of the invention will be illustrated in more detail with reference to the following Examples, but it should be understood that the present invention is not deemed to be limited thereto.

### EXAMPLES

### Example 1. Formulations: Polyolefin

The following polyolefins (CH₂CHR)ₙ, combined with SYLOSIV® K360 3 Å molecular sieve powder as the desiccant and, where indicated, EVA 2528 as the channeling agent (in some of the formulations) were used for study.

TABLE 1
Compositions.

| Sample ID | % desiccant | % EVA | R |
|---|---|---|---|
| 1 | 60% | 0% | C₂H₅ |
| 2 | 40% | | |
| 3 | 60% | 3% | |
| 4 | 40% | | |
| 5 | 60% | 0% | n-C₄H₉ |
| 6 | 40% | | |
| 7 | 60% | 3% | |
| 8 | 40% | | |
| 9 | 60% | 0% | n-C₆H₁₃ |
| 10 | 40% | | |
| 11 | 60% | 3% | |
| 12 | 40% | | |

Other formulations are contemplated with this disclosure. Certain formulations are envisaged using concentrations of EVA between 1% and 15%, for example, at 2%, 3%, 4%, 5%, 6%, 8%, 10%, 12%, and 15%. Other channeling agents are envisioned, including polyglycols such as: polyethylene glycol, (PEG), ethylene-vinyl alcohol (EVOH), and polyvinyl alcohol (PVOH); polyamides such as nylon; and propylene oxide polymerisate monobutyl ether.

### Example 2. Extrusion Conditions

The following conditions were for extrusion experiments.

The samples were ran using blow film machine (LabTech). A first sample labelled M0033 was run at a screw temperature of 350° F. (177° C.) and a die temperature of 350° F. (177° C.). The material was able to flow around the die to form a bubble. Different screw speeds up to 65 rpm were attempted. At lower screw speeds the material does not flow fast enough to reach the nip rolls before it becomes hard and brittle which makes it difficult to get through the nip rolls. At 65 rpm the material is still ductile enough to reach the nip rolls. However, upon cooling, the material becomes hard and brittle which made it difficult to form blown films. The nip roll speed was set at 0.5 ft/min. The external air was set below 500 rpm to avoid rapid cooling.

Blow molding of polyethylene samples at screw and die temperature of 360° F. (182° C.) was attempted. The materials flow around the die and formed bubbles. However, the screw stopped rotating in between the runs. This can be attributed to the size of pelletized/chopped form of the material, which obstructed its uptake by the screw, and periodically blocked the rotational motion of the screw.

For each extrusion experiment, the difficulty of the extrusion process was ranked as “M” (manageable) and “D” (difficult). Characteristics of difficult extrusion experiments include slow formation of the required bubble and breakage or rupture of the material during the processing.

TABLE 2
Extrusion experiments at 15 rpm.(a)

Extruder temp, ° C.

| Sample ID | 150 | 165 | 180 | 190 |
|---|---|---|---|---|
| 1 | D | D | D | — |
| 2 | D | D | D | |
| 3 | M | M | M | — |
| 4 | M | M | D | — |
| 5 | M | M | D | — |
| 6 | M | M | M | — |
| 7 | M | M | D | — |
| 8 | M | M | M | — |
| 9 | — | — | — | M |
| 10 | M | M | M | — |
| 11 | — | M | M | M |
| 12 | M | M | M | — |

(a)D = difficult to form a bubble; M = moderate effort to form a bubble

TABLE 3
Extrusion experiments at 30 rpm.(a)

Extruder temp, ° C.

| Sample ID | 150 | 165 | 180 | 190 |
|---|---|---|---|---|
| 1 | D | D | D | — |
| 2 | D | D | D | |
| 3 | D | D | D | — |
| 4 | M | M | D | — |
| 5 | M | D | D | — |
| 6 | D | D | D | — |
| 7 | M | M | D | — |
| 8 | M | M | D | — |
| 9 | D | D | D | M |
| 10 | M | M | D | — |
| 11 | — | D | D | D |
| 12 | D | D | D | — |

(a)D = difficult to form a bubble; M = moderate effort to form a bubble

Under these conditions, at either 15 or 30 rpm, at any one of 150° C., 165° C., or 180° C., no bubble was formed with any one of polyethylene, polypropylene, or poly(lactic acid). For these materials, a bubble was formed with difficulty at 65 rpm and 180° C.

Furthermore, higher loading could be achieved with formulas having R═C₂H₅, n-C₄H₉, or n-C₆H₁₃ compared to formulas having R═H or CH₃.

Certain further conditions for extrusions are contemplated. Extrusion speeds between 5 rpm and 30 rpm are envisioned. In particular, extrusion speeds chosen from 5, 10, 15, 20, and 25 rpm are envisioned.

### Example 3. EXACT™ Formulations

The following trial formulations were prepared using the following materials:
Base Resin=EXACT™ 3040
Formulation #1=60% K360 SYLOSIV/40% Resin-3040

Compositions of the EXACT™ 3040 formulations, in terms of the base resin and the Formulation #1 mixture, are set forth in Table 4.

TABLE 4
EXACT ™ 3040 Formulations (based on Formulation #1)

| Formula No. | % Base Resin (EXACT ™ 3040) | % Formulation #1 |
|---|---|---|
| #1 | 40% | 60% |
| #2 | 60% | 40% |
| #3 | 75% | 25% |

Compositions of the EXACT™ formulations, in terms of the base resin and the desiccant SYLOSIV® K360, are set forth in Table 5.

### Table 5. EXACT™ 3040 Formulations (Based on Overall Composition)

TABLE 5
EXACT ™ 3040 Formulations (based on overall composition)

| Formula No. | % EXACT ™ 3040 | % SYLOSIV ® K360 |
|---|---|---|
| #1 | 64% | 36% |
| #2 | 76% | 24% |
| #3 | 85% | 15% |

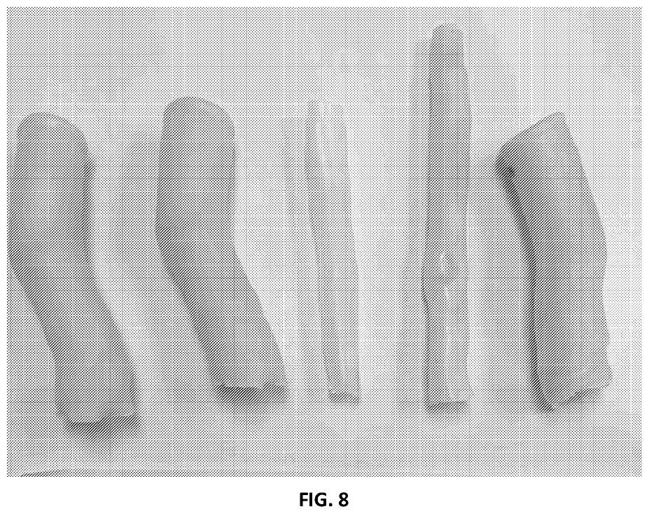

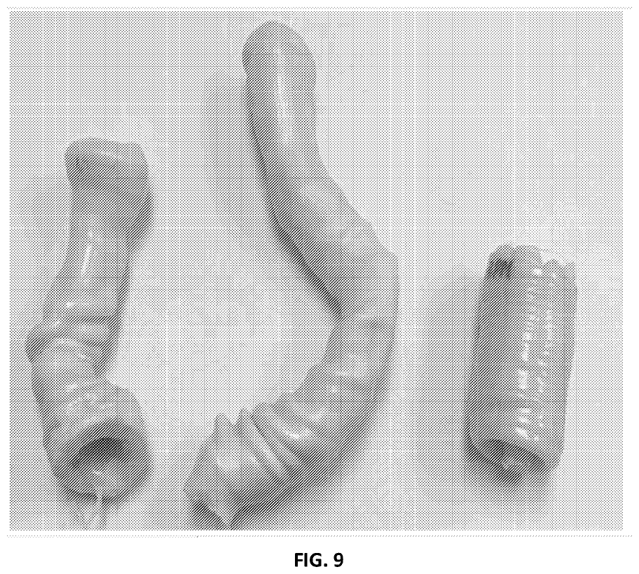

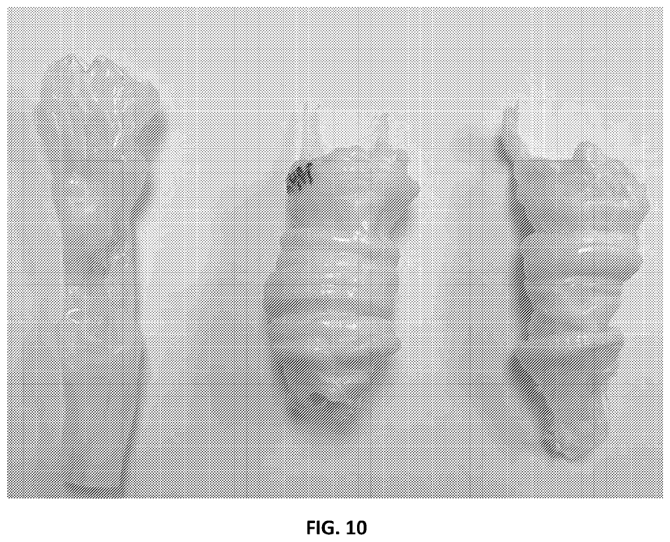

For each extruded sample, the quality of the product was scored as “G” (good), “F” (fair), and “P” (poor). Preferred qualities include thin walls and the absence of surface features such as folds or ridges. Examples of good, fair, and poor quality products are depicted in FIG. 8, FIG. 9, and FIG. 10, respectively.

Ease of bubble formation and quality of the resulting film are reported in Table 6 and Table 7.

TABLE 6
Extrusion experiments for EXACT ™ 3040 formulations. I. (a)(b)

| | | Extruder Temp, ° C. | | | | | |
|---|---|---|---|---|---|---|---|
| Formula | Speed | 150 | | | 165 | | |
| No. | (RPM) | Bubble? | Ease | Quality | Bubble? | Ease | Quality |
| #1 | 65 | Y | M | G | Y | M | G |
| | 55 | Y | M | G | Y | M | G |
| | 45 | Y | M | G | Y | M | G |
| | 35 | Y | M | G | Y | M | G |
| | 25 | Y | M | G | Y | M | F |
| | 15 | Y | M | G | Y | M | F |
| #2 | 65 | Y | M | G | Y | M | F |
| | 55 | Y | M | G | Y | M | F |
| | 45 | Y | M | G | Y | M | F |
| | 35 | Y | M | G | Y | M | F |
| | 25 | Y | M | G | Y | M | F |
| | 15 | Y | M | G | Y | M | F |
| #3 | 65 | Y | M | F | Y | D | F |
| | 55 | Y | M | F | Y | D | F |
| | 45 | Y | M | F | Y | D | F |
| | 35 | Y | M | F | Y | D | F |
| | 25 | Y | M | F | Y | D | F |
| | 15 | Y | M | F | Y | D | F |

(a) “Ease” = ease of forming bubble: D = difficult; M = moderate.
(b) “Quality” = quality of film: G = good; F = fair; P = poor.

TABLE 7
Extrusion experiments for EXACT ™ 3040 formulations. II. (a)(b)

| | | Extruder Temp, ° C. | | | | | |
|---|---|---|---|---|---|---|---|
| | Speed | 180 | | | 190 | | |
| Trial # | (RPM) | Bubble? | Ease | Quality | Bubble? | Ease | Quality |
| #1 | 65 | Y | M | G | Y | M | F |
| | 55 | Y | M | G | Y | M | F |
| | 45 | Y | M | F | Y | M | F |
| | 35 | Y | M | F | Y | M | F |
| | 25 | Y | M | F | Y | M | F |
| | 15 | Y | M | F | Y | M | F |
| #2 | 65 | Y | M | F | Y | M | F |
| | 55 | Y | M | F | Y | M | F |
| | 45 | Y | M | F | Y | M | F |
| | 35 | Y | D | F | Y | M | F |
| | 25 | Y | D | F | Y | D | F |
| | 15 | Y | D | F | Y | D | F |
| #3 | 65 | Y | D | F | Y | D | P |
| | 55 | Y | D | F | N | D | P |
| | 45 | Y | D | F | N | D | P |
| | 35 | Y | D | F | N | D | P |
| | 25 | Y | D | F | N | D | P |
| | 15 | Y | D | F | N | D | P |

(a) “Ease” = ease of forming bubble: D = difficult; M = moderate.
(b) “Quality” = quality of film: G = good; F = fair; P = poor.

### Example 4. EXACT™ 3040 HYTREL® 7246 Polyester Formulations

The following trial formulations were prepared using the following materials:

Compositions of the EXACT™ 3040 and polyester formulations are set forth in Table 8.

TABLE 8
EXACT ™ 3040/HYTREL ® 7246 Formulations
(based on Formulation #1)

| Formula No. | % HYTREL ® 7246 | % Formulation #1 |
|---|---|---|
| #4 | 60% | 40% |
| #5 | 70% | 30% |
| #6 | 75% | 25% |

TABLE 9
EXACT ™/HYTREL ® 7246 Formulations
(based on overall composition)

| | % EXACT ™ | % HYTREL ® | % SYLOSIV ® |
|---|---|---|---|
| Formula No. | 3040 | 7246 | K360 |
| #4 | 16% | 60% | 24% |
| #5 | 12% | 70% | 18% |
| #6 | 10% | 75% | 15% |

Ease of bubble formation and quality of the resulting film are reported in Table 10 and Table 11.

TABLE 10
Extrusion experiments for EXACT ™/HYTREL ® 7246
formulations. I. (a)(b)

| | | Extruder Temp, ° C. | | | | | |
|---|---|---|---|---|---|---|---|
| | Speed | 150 | | | 165 | | |
| Trial # | (RPM) | Bubble? | Ease | Quality | Bubble? | Ease | Quality |
| #4 | 65 | Y | M | G | Y | M | G |
| | 55 | Y | M | G | Y | M | G |
| | 45 | Y | M | G | Y | M | G |
| | 35 | Y | M | G | Y | M | G |
| | 25 | Y | M | G | Y | M | G |
| | 15 | Y | M | G | Y | M | G |
| #5 | 65 | Y | M | G | Y | M | G |
| | 55 | Y | M | G | Y | M | G |
| | 45 | Y | M | G | Y | M | G |
| | 35 | Y | M | G | Y | M | G |
| | 25 | Y | M | G | Y | M | G |
| | 15 | Y | M | G | Y | M | G |
| #6 | 65 | Y | M | G | Y | M | G |
| | 55 | Y | M | G | Y | M | G |
| | 45 | Y | M | G | Y | M | G |
| | 35 | Y | M | G | Y | M | G |
| | 25 | Y | M | G | Y | M | G |
| | 15 | Y | M | G | Y | M | G |

(a) “Ease” = ease of forming bubble: D = difficult; M = moderate.
(b) “Quality” = quality of film: G = good; F = fair; P = poor.

TABLE 11
Extrusion experiments for EXACT ™/HYTREL ® 7246
formulations. II. (a)(b)

| | | Extruder Temp, ° C. | | | | | |
|---|---|---|---|---|---|---|---|
| | Speed | 180 | | | 190 | | |
| Trial # | (RPM) | Bubble? | Ease | Quality | Bubble? | Ease | Quality |
| #4 | 65 | Y | M | G | Y | M | G |
| | 55 | Y | M | G | Y | M | G |
| | 45 | Y | M | G | Y | M | G |
| | 35 | Y | M | G | Y | M | G |
| | 25 | Y | M | G | Y | M | G |
| | 15 | Y | M | G | Y | M | G |
| #5 | 65 | Y | M | G | Y | M | G |
| | 55 | Y | M | G | Y | M | G |
| | 45 | Y | M | G | Y | M | F |
| | 35 | Y | M | G | Y | M | F |
| | 25 | Y | M | G | Y | M | F |
| | 15 | Y | M | G | Y | M | F |
| #6 | 65 | Y | M | G | Y | M | F |
| | 55 | Y | M | G | Y | M | F |
| | 45 | Y | M | G | Y | M | F |
| | 35 | Y | M | G | Y | M | F |
| | 25 | Y | M | G | Y | M | F |
| | 15 | Y | M | G | Y | M | F |

(a) “Ease” = ease of forming bubble: D = difficult; M = moderate.
(b) “Quality” = quality of film: G = good; F = fair; P = poor.

### Example 5. Moisture Absorbance

A selection of 5 films (3× each) of the EXACT™ 3040 formulation of Example 3, and 11 films (3× each) of the EXACT™ 3040/HYTREL® formulation of Example 4, were cut into 1 inch squares and placed in humidity chamber (80%). The squares were weighed twice every day for two weeks.

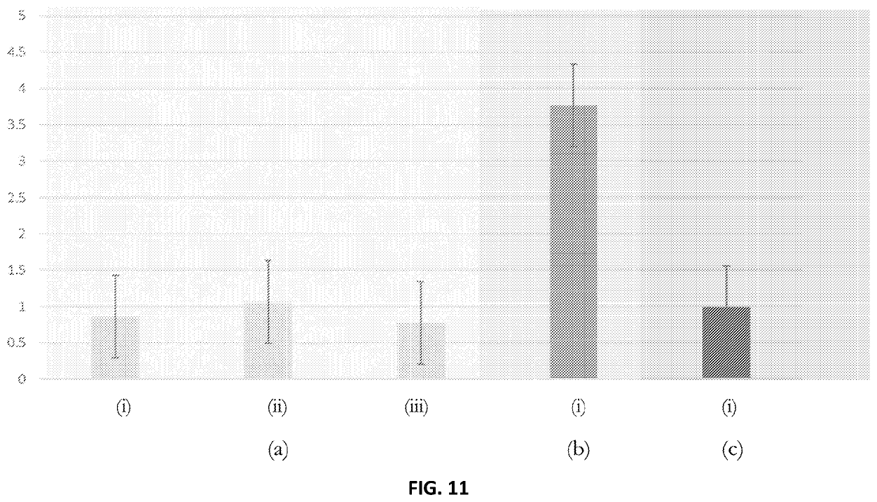

FIG. 11 depicts moisture uptake, in g/day (vertical axis), for blown films comprising EXACT™ 3040. The graphs are designated with extrusion temperature: (a) 150° C. (b) 165° C. (c) 180° C. Formulations: (i) #1 (60% Formulation #1) (ii) #2 (40% Formulation #1) (iii) #3 (25% Formulation #1).

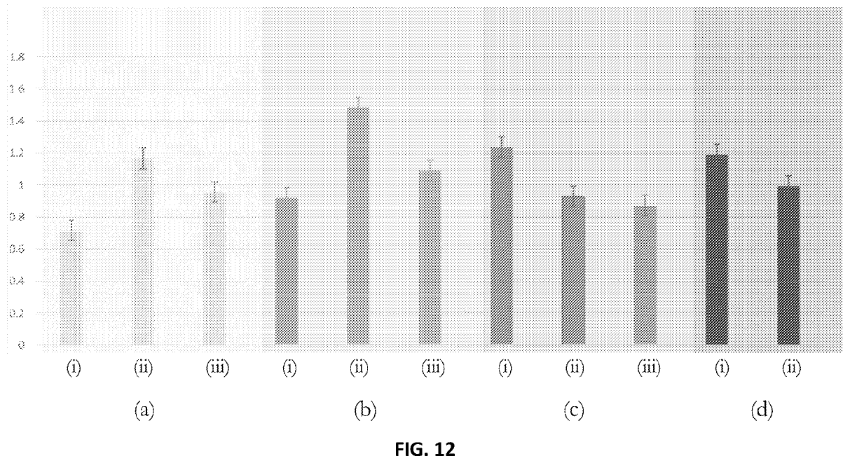

FIG. 12 depicts moisture uptake, in g/day, for blown films comprising mixtures of EXACT™ 3040 and HYTREL® 7246. The graphs are designated with extrusion temperature: (a) 150° C. (b) 165° C. (c) 180° C. (d) 190° C. Formulations: (a) #4 (40% Formulation #1) (b) #4 (30% Formulation #1) (c) #4 (25% Formulation #1).

While the disclosed concept has been described in detail and with reference to specific examples thereof, it will be apparent to one skilled in the art that various changes and modifications can be made therein without departing from the spirit and scope thereof.

What is claimed is:

1. A blown film material comprising:
a base polymer; and
an active agent, wherein the active agent is a granular, particulate and/or mineral-based material.

2. (canceled)

3. The blown film material as recited in claim 1, wherein the base polymer is a polyolefin having formula (—CH₂CHR—)ₙ, wherein R is chosen from H and n-C₁₋₁₀alkyl.

4. The blown film material as recited in claim 1, wherein the base polymer is a polyester.

5. (canceled)

6. (canceled)

7. (canceled)

8. The blown film material as recited in claim 3, wherein R is chosen from H, CH₃, C₂H₅, C₄H₉, n-C₆H₁₃, and n-C₈H₁₇.

9. The blown film material as recited in claim 3, wherein R is chosen from C₂H₅, n-C₄H₉, and n-C₆H₁₃.

10. (canceled)

11. (canceled)

12. (canceled)

13. (canceled)

14. The blown film material as recited in claim 1, wherein the base polymer comprises an ethylene/alpha-olefin copolymer.

15. The blown film material as recited in claim 14, wherein the alpha-olefin is chosen from propylene, 1-butene, 1-pentene, 1-hexene, 1-heptene, 1-octene, 1-nonene, and 1-decene, and 1-dodecene.

16. The blown film material as recited in claim 15, wherein the alpha-olefin is 1-hexene.

17. (canceled)

18. The blown film material as recited in claim 14, wherein the base polymer further comprises a block copolymer that comprises a block of poly(alkylene) terephthalate monomers.

19. The blown film material as recited in claim 18, wherein the block copolymer comprises a block of poly(butylene) terephthalate monomers.

20. The blown film material as recited in claim 19, wherein the block copolymer comprises a block of polyether glycols.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The blown film as recited in claim 1, wherein the active agent is a desiccant.

40. The blown film material as recited in claim 39, wherein the desiccant is chosen from silica gel and molecular sieve.

41. The blown film material as recited in claim 40, wherein the desiccant is 3 Å molecular sieve.

42. The blown film material as recited in claim 39, wherein the desiccant comprises 35% to 70% by weight with respect to the total weight of the blown film material.

43. (canceled)

44. (canceled)

45. The blown film material as recited in claim 1, further comprising a channeling agent that is provided in a range of 1% to 15% by weight.

46. The blown film material as recited in claim 45, wherein the channeling agent is chosen from a polyglycol, glycerin polyamine, polyurethane, polycarboxylic acid, propylene oxide polymerisate, propylene oxide polymerisate-monobutyl ether, ethylene vinyl acetate (EVA) and nylon, or any combination of the foregoing.

47. (canceled)

48. (canceled)

49. The blown film material as recited in claim 45, wherein a 1 inch square of the blown film material absorbs moisture in an 80% relative humidity atmosphere at ambient temperature with a rate of at least 0.2 g/day.

50. The blown film material of claim 1 wherein a physical property chosen from clarity, tear strength, elongation, puncture resistance, toughness, Young's modulus, dart impact resistance, transparency, brittleness, and density is significantly different for the blown film material as compared to a comparable cast film material.

51. A method for manufacturing the blown film material as recited in claim 1, comprising the steps of:
extruding a suitable precursor material in a screw extruder with warming;
passing the warmed material through a tubular die;
expanding and stretching the warmed material with positive pressure; and
allowing the expanded and stretched material to cool.

52. The method as recited in claim 51, wherein the extrusion is performed with a rotation speed of between 15 rpm and 65 rpm and at a temperature of between 145° C. and 175° C.

53. (canceled)

54. (canceled)

55. The method as recited in claim 51, wherein the method includes coextrusion of at least two layers for forming the expanded and stretched material, at least one layer including a polymer material without an active agent mixed therein.

56. (canceled)

57. (canceled)

58. (canceled)

59. (canceled)

60. (canceled)

61. (canceled)

62. (canceled)

63. (canceled)

64. (canceled)

65. (canceled)

66. The method as recited in claim 51, wherein the base polymer is a polyolefin having formula (—CH₂CHR—)ₙ, wherein R is chosen from H and n-C₁₋₁₀alkyl.
